(19) United States
(12) Patent Application Publication
(10) Pub. No.: US 2025/0166229 A1
(43) Pub. Date: May 22, 2025

(54) STRUCTURED DATA SHARING USING DIGITALLY ENCODED IMAGES

(71) Applicant: Cerner Innovation, Inc., Kansas City, MO (US)

(72) Inventors: Winston Rohan Dsouza, Melbourne (AU); Andrew Gabriel Mani, Karnataka (IN); Heenal Keshwani, Karnatake (IN); Palak Sharma, Karnataka (IN)

(73) Assignee: Cerner Innovation, Inc., Kansas City, MO (US)

(21) Appl. No.: 18/799,933

(22) Filed: Aug. 9, 2024

Related U.S. Application Data
(60) Provisional application No. 63/599,927, filed on Nov. 16, 2023.

(51) Int. Cl. G06T 9/00; G06T 3/40; G06V 10/24; G06V 10/56; G06V 10/60; G06V 10/75

(52) U.S. Cl. CPC G06T 9/00; G06T 3/40; G06V 10/24; G06V 10/56; G06V 10/60; G06V 10/751

(57) ABSTRACT

Techniques relate to efficiently encoding data. A data set in a first specific format is received. The data set is transformed into data-string values in a second specific format, where the data-string values includes a set of data-string values, wherein each of the set of data-string values is represented by an intensity for each of one or more channels. A digitally encoded image is generated by transforming the data-string data into an image comprising a pixel value for each of a set of pixels, wherein the pixel values for the set of pixels have at least three different intensities and/or at least three different colors relative to each other. The transformation may include generating the data set or a representation thereof in a hexadecimal format. The digitally encoded image is output.

### CROSS-REFERENCE TO RELATED APPLICATIONS

This application claims the benefit of and the priority to U.S. Provisional Patent Application 63/599,927, filed on Nov. 16, 2023, which is hereby incorporated by reference in its entirety for all purposes.

### BACKGROUND

Communicating data between various systems is becoming increasingly prevalent and important, as data collection is becoming more prevalent. Such data communication may occur across systems within a given entity (e.g., a given company) or across entities. Data warehousing is one technique to support such communication, in which a central data repository and/or a data warehouse is used to share data with the multiple entities including applications, devices, and/or organizations within a secured and structured network system. For example, electronic health information exchange (HIE) supports access and sharing of the medical data with the entities that are within a dedicated secured and structured network system. Beyond the network of hospitals that the HIE is configured for, sharing of medical data poses a challenge, as confirmation of data-sharing and/or data-editing permissions becomes complicated.

However, data collection is becoming increasingly prevalent and computations are becoming increasingly sophisticated, meaning that the data that is available for storage or communication is becoming drastically larger in size. In the meantime, the speed at which data is expected to be available has decreased. Thus, there is a need to more efficiently represent large and complex data sets.

Further, cloud systems have been very useful to support sharing large data sets. In these instances, a computing system sending the data can upload the data to the cloud system, and another computing system can access and/or download the data at a later time, without needing to store the data (in the meantime or at all). However, this means that accessing the data (at least before any download) requires a network connection (e.g., an Internet connection). In some instances, rapid data access is too high of a priority to risk potential inaccessibility due to a potential network failure. Similarly, there are different constraints on sharing data across various sub-networks of computing systems. Though those constraints may have been established for good reason, they may fail to be applicable in all instances and may therefore result in thwarting important data transmission in various circumstances. Thus, there is a need to efficiently communicate large and complex data sets in a manner that is resistant to potential network failures.

Further yet, communicating data in a manner that accords with an interpretable data structure is important. While data sets can be encoded in various manners to reduce their data sizes, such encoding is of limited utility if decoding the data is unreliable and/or time-intensive. For example, in the medical context, sharing data in compliance with the HL7 protocol can be instrumental to saving lives, and time is of the essence. Thus, there is a need to efficiently communicate large and complex data sets in a reliable manner that facilitates consistent and efficient decoding.

### BRIEF SUMMARY

In some embodiments, a computer-implemented method is provided that includes: receiving a data set in a first specific format; transforming the data set into data-string values in a second specific format, wherein the data-string values includes a set of data-string values, wherein each of the set of data-string values is represented by an intensity for each of one or more channels; generating a digitally encoded image by transforming the data-string data into an image comprising a pixel value for each of a set of pixels, wherein the pixel values for the set of pixels have at least three different intensities and/or at least three different colors relative to each other; and outputting the digitally encoded image.

The transformation may include: transforming the data set from the first specific format into another data set in a ASCII format and potentially transforming the other data set in the ASCII format to data in a binary format.

The transformation may include generating the data set or a representation thereof in a hexadecimal format.

The transformation may include: generating data in a hexadecimal format, wherein the hexadecimal format utilizes one or more pixels to represent a given hexadecimal value.

The transformation may include: generating data in a grayscale format, wherein the grayscale format is configured to use a scale with at least three distinct values.

The transformation may include: generating data in a multi-channel color format, such that each or multiple pixels in the digitally encoded image is represented by a set of channel values that were generated based on the data set.

Outputting the digitally encoded image may include: presenting the digitally encoded image.

Outputting the digitally encoded image may include: transmitting the digitally encoded image.

Generating a digitally encoded image may include integrating an orienting indicator to facilitate adjusting skew, scale, or orientation of the digitally encoded image.

The pixel values of the set of pixels in the digitally encoded image may include grayscale values.

The pixel values of the set of pixels in the digitally encoded image may include multi-channel color values.

The transformation may include: transforming a received graphical representation into a grid of pixel-specific values to detect one or more orienting indicators and adjusting an image property.

The digitally encoded image may include a portion that includes an additional set of pixels that are ordered or labeled in a manner that indicates, for each pixel of the additional set of labels, a data value that the pixel is to represent.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an exemplary code-generation system to generate a code for efficiently representing input data.

FIG. 2 illustrates how various hexadecimal values may be represented in 6 hexadecimal digits, with each representing information that—in a binary context—would be represented by 4 binary digits.

FIGS. 3A-3B show two illustrative graphical representations with pixels in a hexadecimal format that include an orienting indicator that indicates which corner of the code is to be read as the first (top-left) corner of the code.

FIG. 4 illustrates a flow chart of an exemplary process pertaining to encoding data.

FIG. 5 illustrates a computing device that is facilitating data sharing and interoperability based on an efficient graphical representation of data.

FIG. 6 depicts a simplified diagram of a distributed system for implementing an embodiment.

FIG. 7 is a simplified block diagram of a cloud-based system environment in which various text handling-related services may be offered as cloud services, in accordance with certain aspects.

FIG. 8 illustrates an exemplary computer system 800 that may be used to implement certain aspects.

FIG. 9 illustrates encoding to a standard medical terminology.

FIG. 10 illustrates an exemplary process flow involving XS-Codes (with hexadecimal signals).

FIG. 11 illustrates an exemplary process flow involving XS-Codes (with hexadecimal signals).

### DETAILED DESCRIPTION

In some embodiments, techniques are provided to encode complex and large input data sets into a compact graphical representation and/or to decode such a representation. The data being encoded into the compact graphical representation may include health and/or medical data, such as electronic health information exchange (HIE) data or electronic medical record (EMR) data, though various other types of data may be additionally or alternatively encoded. These techniques can result in secure and efficient data storage and/or sharing without the conventional limitations related to network connectivity and bandwidth. Disclosed techniques provide encoding/decoding mechanisms that reliably and efficiently indicate specific data in a manner that preserves data integrity beyond existing techniques.

### Overview

Generating the graphical representation may include transforming an input data set to include a graphical representation, where the graphical representation includes a vector (e.g., bar code) or grid (e.g., two-dimensional QR-code), where each pixel is a binary value. A pixel may include a hexadecimal value, a grayscale value (e.g., a value on a 0-255 scale), or a multi-channel color value (e.g., an RGB value with red, green and blue channels or CMYK value with cyan, magenta, yellow, and key channels). As referred to herein, an XS-code is a graphical representation that includes pixels with hexadecimal values; an WS-code is a graphical representation that includes pixels with grayscale values; and a PS-code is a graphical representation that includes pixels with multi-channel color values.

The input data set may include a file with text and/or numbers. The transformation may include transforming the input data set one or more times to arrive at pixel values with a target format. For example, the transformation may include transforming data of the file into an ASCII format, transforming the ASCII-formatted data into a binary string, and then transforming the binary string into the target format. The transformation from the binary string to the target format may improve the efficiency of the data representation, given that-when using the target format of Hexadecimal values—each pixel may be defined to have a non-binary value, such data can be represented more efficiently than with binary signals.

As further described below, it will be appreciated that a graphical representation with multi-channel color values (where each channel can be assigned a value on a 0-255 scale) can more efficiently represent data as compared to a graphical representation with grayscale values (across a 0-255 grayscale) or with hexadecimal values. However, the usefulness of efficient encoding also depends on the reliability of corresponding decoding. That reliability is degraded if a decoding system cannot properly differentiate between different potential values. For example, a decoding system may receive a depiction of the graphical representation that was captured by a camera. If a single- or multi-channel pixel is assigned values across a channel with a large number of potential values, an image received by the decoding system (e.g., where the image was captured by a camera, scanner, etc.) may fail to reliably capture the precise channel values. For example, lighting variation in various environments in which the captured photo was taken may result in imprecise channel-value detections. Accordingly, it will be appreciated that graphical representations that use finer grain scales for pixel values (e.g., one or more 0-255 scales) may be more useful in environments with less noise (e.g., digital transmission of the graphical representations between computing systems). Meanwhile, more coarse (but still non-binary) scales may be more useful in environments with more noise (e.g., relying on camera capture of the graphical representation).

The graphical representation may include a portion that provides information as to how each depicted intensity or color corresponds to or represents a given data value. As one example, such a portion may include, for example, a legend that visually and/or spatially associates a given intensity or color with a given data value. As another example, such a portion may depict an ordered set of colored pixels. This portion may be particularly helpful in decoding a graphical representation that has been printed by a printer or captured by a camera, given that printer quality, ink levels, and/or lighting can be inexact. The portion may then be used be utilized (for example) for normalization or standardization. The portion may be positioned in a pre-defined location and/or fraction of the graphical representation. For example, the portion may be positioned to occupy a predefined set of specified pixels, a predefined set of one or more columns/rows, a predefined pattern of pixels, etc.

In some embodiments, a camera captures an image of the graphical representation. The information as to how each depicted intensity or color corresponds to or represents a given data value may be detected, decoded, determined or predicted. For example, in one instance, a portion of the graphical representation (e.g., displayed along a portion of the graphical representation, such as a side of the perimeter) may be configured to associate each of multiple colors or intensities with a given data value. In this instance, even if the graphical representation was produced using a printer with low ink (of one or more colors) or was captured under poor lighting, each pixel may be accurately translated. As another example, the portion is at a predefined spatial region of the graphical representation and includes pixels with colors or intensities in a pre-defined, known, or determinable order. To illustrate, though a pixel that is purely red may represent a given data value in one instance, the portion may instead indicate that the given data value is to be associated with 90% red and 10% green (potentially due to a printer or lighting issue that did not result in capturing what was initially defined to be a “red” pixel).

The graphical representation may also include or may represent a data-sharing restriction. For example, decoding of data may be conditioned upon detecting that one or more identifiers (e.g., a medical-facility identifier or medical-network identifier) matches and/or accords with one or more corresponding identifiers included or represented in the graphical representation.

Embodiments of the present invention improve over the conventional data sharing techniques by being able to more efficiently communicate data, while preserving reliability of the transferred data. Further, a central data repository and/or network access need not be used to communicate the information (when an encoding/decoding scheme is locally stored on corresponding devices).

### Exemplary Techniques for Efficiently Encoding and Communicating Data

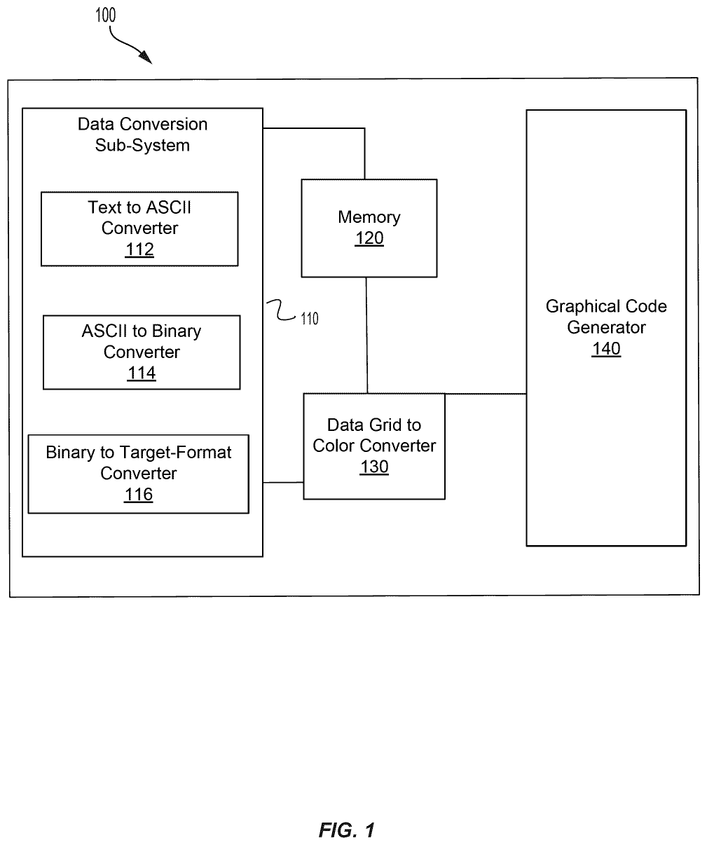

FIG. 1 shows an exemplary code-generation system to generate a code for efficiently representing input data.

As illustrated in FIG. 1, a computing device 100—that is facilitating data sharing and interoperability based on an efficient graphical representation of data-includes a Data-Conversion Sub-System 110 including a Text to ASCII converter 112, an ASCII to Binary Converter 114, and a Binary to Target-Format Converter 116. It will be appreciated that each of one or more of the Data-Conversion Sub-System 110, the Text to ASCII converter 112, the ASCII to Binary Converter 114, and the Binary to Target-Format converter 116 may correspond to specialized non-transitory code (e.g., one or more functions, code portions, sub-routines, etc.) that, when executed on a processor perform specialized function described herein. It will be appreciated that one more or all of the processing actions may be performed remotely from a device that accesses the data to be represented in the graphical representation. It will also be appreciated that one more or all of the processing actions may be performed locally at a device that accesses the data to be represented in the graphical representation.

The Data-Conversion Sub-System 110 may be communicatively coupled to a memory 120 that stores data values received from the Data-Conversion Sub-System 110. The Data-Conversion Sub-System 110 and the memory 120 may further be communicatively coupled to a Data Grid to Color Converter 130 for receiving the data values computed by the Data-Conversion Sub-System 110 and/or for receiving the stored data values from the memory 120 and facilitating transforming the values to a graphical representation. For example, the Data-Conversion Sub-System 110 may identify any constraints that are imposed on graphical images for a given context (e.g., client, use case, time period, etc.) and coordinating with a Graphical Code Generator 140 to generate the graphical code in view of the constraints.

The Data-Conversion Sub-System 110 may access, obtain, or receive a data set and/or information in an initial format, which may include a file format, such as a .TXT format or .XML format. The initial format may include a set of input strings.

For example, the data set may include (for example) log data representing network requests and/or responses, computer-performance metrics representing responsiveness and/or latencies of one or more computing devices, medical data representing part or all of one or more electronic health records, autonomous-driving data representing when and/or how autonomous-driving software was activated and/or disengage, network-load data representing when and/or how various portions of a network are loaded with various tasks, etc.

The data set can be transformed, by the Text to ASCII converter 112, into a standardized format that reliably represents various characters. For example, letters, numbers, special characters, etc. in the received data set are represented by their corresponding specific ASCII values. ASCII is a 8-bit character set that contains 256 characters.

The ASCII to Binary converter 114 may be configured to generate binary data-string values based on the ASCII values. Given that each value in binary data string is assigned one of two values, the binary data string is larger in size relative to the ASCII data string.

A target-format data set is then generated by the Binary to Target-Format Converter by transforming the binary data string into a data string or data array with values in a target format. The target format can be one that has a scale for values that is a continuous scale or that is a discretized scale with (for example) at least 3, at least 4, at least 5, at least 6, at least 12, at least 24, at least 48, at least 96, at least 124, or at least 256 values. The target format may include (for example) a hexadecimal format represented over a custom-channel color format or a grayscale format, or a multi-channel color format. Thus, the target-format data set may more efficiently represent data relative to the binary data set.

It will be appreciated that an efficiency of the transformation occurring at the Binary to Target-Format Converter depends on an entropy and/or scale of the target format. That is, more binary values can be represented in a given target-format value when the scale in the target format and/or an entropy of the scale in the target format is higher. Therefore, when the target format includes multiple channels with 8-bits per channel, data can be represented more efficiently (and with fewer pixels) than when a target format includes a single channel with 8-bits per channel. Similarly, when the target format includes a channel with 8-bits per channel, data can be represented more efficiently (and with fewer pixels) than when a target format includes a Hexadecimal (4-bit) channel.

While not shown here, the Data-Conversion Sub-System 110 may further include a structure converter that is configured to transform a structure of data, so as to (for example) filter and/or reorganize data. For example, a structure converter may detect representations of various key-value pairs and may generate an organized representation of part or all of the key-value pairs. The part or all of the key-value pairs may include an incomplete subset of the initially represented data. Thus, a given client may identify particular types of data that is requested to be reliably transmitted in graphical representations, and any remaining data (in some embodiments) may be discarded to improve efficiency. Further or alternatively, if a structure is well-defined for a given client, the graphical representation may be configured so as to not explicitly represent keys, context data, etc. To illustrate, if a given client defines a structure so as to indicate that a first pixel is to represent an age bracket, the graphical representation need not include an additional pixel that is a key so as to define what the corresponding “age-bracket” value is. The structure converter may introduce a pre-defined and/or client-specific structure (for example) before and/or while: input data is being transformed to ASCII data, ASCII data is being transformed into binary data, and/or binary data is being transformed into target-format data.

The memory 120 may store and avail various data sets during the transformation process. For example, the computer memory 120 may store ASCII data after it has been generated by the Text to ASCII Converter 112, such that it can be availed to the ASCII to Binary Convert 114.

It will be appreciated that, in some instances, multiple modules of the Data-Conversion Sub-System 110 may be concurrently performing processing in relation to a given data set. Such a process can occur when the data is processed linearly and sequentially. For example, consider a situation where a binary file is structured to first include a first value representing a medical condition of a subject and then include a second value representing a treatment plan for the subject, and where the target format is configured to represent the same values (in a different format) in the same order. As soon as the ASCII to Binary Converter 114 transforms the ASCII representation of the first value to the binary format (and before it has completed transforming the ASCII representation of the second value to the binary format), the Binary to Target-Format Converter 116 may begin transforming the binary-format first value to a target format. Given this concurrent-processing possibility, it may be advantageous to integrate any structure converter earlier in the processing pipeline as compared to later. For example, it may be advantageous to implement the structure converter before the Text to ASCII Converter 112. As another example, it may be more advantageous to implement the structure converter between the Text to ASCII Converter 112 and ASCII to Binary Converter 114 relative to implementing it after the ASCII to Binary Converter 114. As yet another example, it may be more advantageous to implement the structure control between the ASCII to Binary Controller 114 and Binary to Target-Format Controller 116 relative to after the Binary to Target-Format Controller 116.

It will further be appreciated that various data-compression techniques may be performed prior to or after one or more conversions indicated herein. Such a data-compression technique may be (for example) a predefined data-compression technique or a data-compression technique that is customized (e.g., via learning of parameters) for a given client, context, time period, etc. Such learning may occur based on (for example) user feedback that indicates useful data points recorded subsequent events (e.g., medical events indicating medical outcomes associated with subjects for which data had been communicated using graphical representations), an analysis (e.g., information-theory analysis, regression analysis, interpretable neural-network analysis, etc.) that indicates a usefulness of a given data point in predicting an outcome of interest, etc.

The Data Grid to Color Converter 130 may be configured to encode the data-string corresponding to an array structure. The array structure may include (for example) a one-dimensional array (e.g., a grayscale bar code or color bar code) or a two-dimensional array. The array accords with one or more size constraints. For example, a two-dimensional array may be constrained to have no more than a predefined number of pixels along each of one or more dimensions. The array structure may additionally or alternatively be defined flexibly, such that a size of one or more dimensions may be determined dynamically based on a size and/or content of input data.

The array structure may be associated with a set of pixels of the digital image such that each of the data-string values is represented by a set of intensities and/or colors associated with the corresponding set of pixels in the array. For example, each pixel in an XS-code, WS-code, or PS-code can include a set of pixels where each of the set of pixels is defined as a hexadecimal value represented as a custom-channel value, or a grayscale value, or a multi-channel value (respectively).

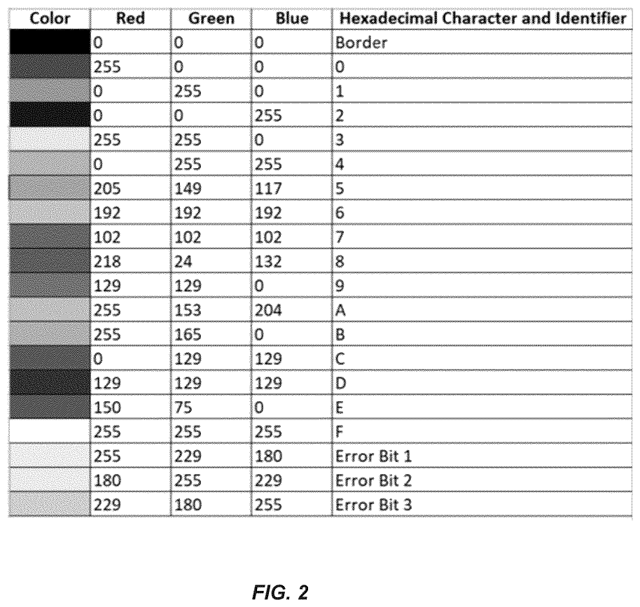

The Graphical-Code Generator 140 can transform the array structure into a graphical representation. For each data value in the array structure, the data value can be transformed into a color and/or intensity of one or more pixels in the graphical representation. For example, FIG. 2 illustrates how various hexadecimal values may be represented in 6 hexadecimal digits, with each representing information that—in a binary context—would be represented by 4 binary digits. Thus, two hexadecimal digits per color corresponds to 8 bits of information. As another example, each grayscale value may be mapped to an intensity of a color (e.g., an intensity along a white-to-black color spectrum or an intensity along a spectrum spanning one or more other colors). As yet another example, each multi-channel value may be mapped to a color by weighting and aggregating respective strengths across channels.

The graphical representation may include an identifier that indicates that the representation complies with data-encoding scheme as disclosed herein and/or that the representation complies with a given structure (e.g., defined by a client, standard, etc.). The graphical representation may include an orienting indicator to facilitate pre-processing (e.g., to facilitate changing a skew, rotation, scale, perspective, etc.). Such pre-processing may be performed to (for example) map the input image into a default image space, such that an image value (e.g., a grayscale or multi-channel value) can be assigned for each pixel.

The graphical representation may include a visual indicator as to what portion of a given input or file is the data that is to be decoded and/or used for decoding. For example, a black border of at least a given thickness may define such as an area for input image data. As another example, one or more tags can be used to denote such a set of values when the values are communicated between devices electronically.

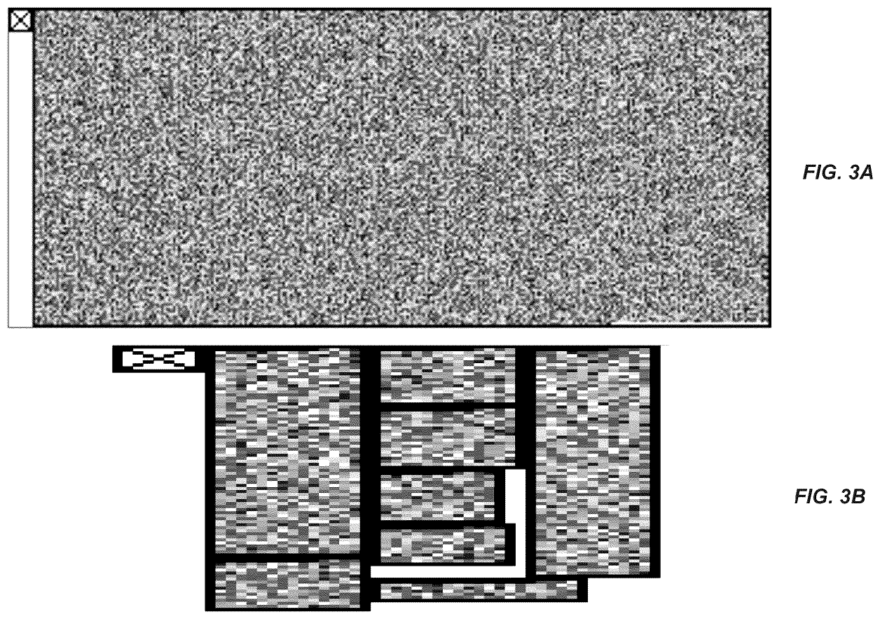

FIGS. 3A-3B show two illustrative graphical representations with pixels in a hexadecimal format that include an orienting indicator that indicates which corner of the code is to be read as the first (top-left) corner of the code. Notably, FIG. 3A aggregates all data together, whereas FIG. 3B includes visual markers that separate various portions of the data.

Once the graphical representation is generated and/or once the digitally encoded image is generated based on the transformation of the array with distinct color coding in the image, the graphical representation may be transmitted and/or availed. For example, the graphical representation may be electronically from a first device (e.g., that availed the data set in the first format) to a second device. As another example, the graphical representation may be availed to a first device (e.g., that availed the data set in the first format or to another device) in a printable or displayable format.

Thus, the graphical representation may be communicated via electronic communication (e.g., via Bluetooth, BTLE, WiFi, the Internet, etc.) or via a receiving device imaging a printed or displayed version of the representation.

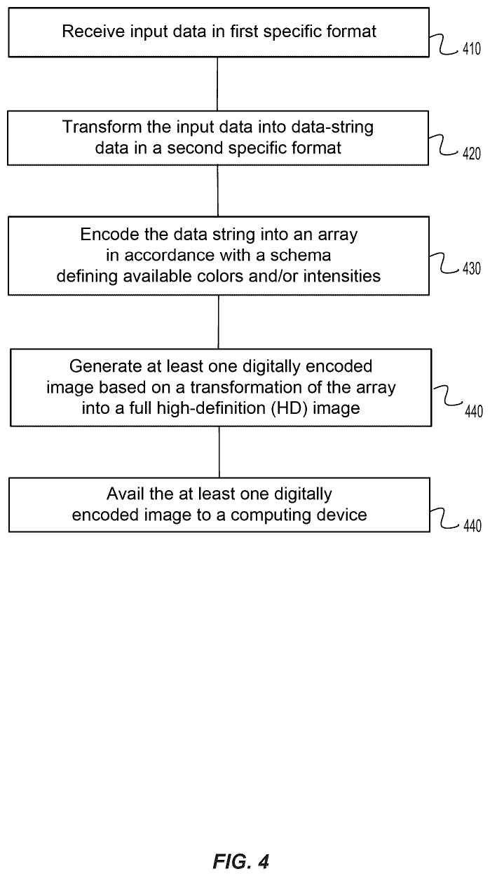

FIG. 4 illustrates a flow chart of an exemplary process pertaining to encoding data. At block 410, a data set is received that is in a first format (such as a .XML format, .TXT format, etc.). The data set can include (for example) alphanumeric representation of information, textual data, image data, structured data and/or unstructured data. The data set may include (for example) medical data and/or all or part of an electronic health record. The data may be received by a user having transmitted a data-encoding request via an interface. The user may be a person for which data in the data set characterizes, a person providing care for a person for which data in the data set characterizes, etc.

At 420, the data set is transformed into a data-string corresponding to a second specific format. The second specific format may include (for example) a hexadecimal format, a multi-channel color format (e.g., RGB format), or a one-channel intensity format. The transformation may be a multi-step transformation. For example, the received data set may be transformed from the first format into a first intermediate data set with an ASCII format, which may then be transformed into a second intermediate data set with a binary format, which may then be transformed into a data set with the second specific format.

At 430, the data-string is encoded into an array that can be associated with a set of pixels of the digital image. As such, each of the data-string values is represented by one or more colors and/or intensities corresponding one or more pixels in the array. For example, each data-string value may be transformed into: one or more colors corresponding to a hexadecimal scale, one or more grayscale values, or one or more multi-channel color values (e.g., RGB values). It will be appreciated that an efficiency at which pixel values represent data from the data set depends on the number of potential values to which each pixel can be defined and also a degree to which potential input values are discretized. In some instances, when the second specific format is a hexadecimal format, each hexadecimal number is transformed into two pixel colors (e.g., that are to be used to color two adjacent pixels).

At 440, a digitally encoded image is generated based on the array. The image may include a graphical representation of a one- or multi-dimension array, where the representation include hexadecimal color, multi-dimensional color (e.g., RGB color), grayscale color, etc. The image may further include one or more identifiers and/or visual indicators so as to (for example) facilitate detecting which portion of the image includes encoded data, how to pre-process a capture of the image, a decoding technique, etc.

At block 450, the digitally encoded image is output. For example, the image may be locally presented at a computing device (e.g., to facilitate display and/or printing). As another example, the image may be transmitted to another computing device.

### Exemplary Techniques for Efficiently Decoding and Using Data

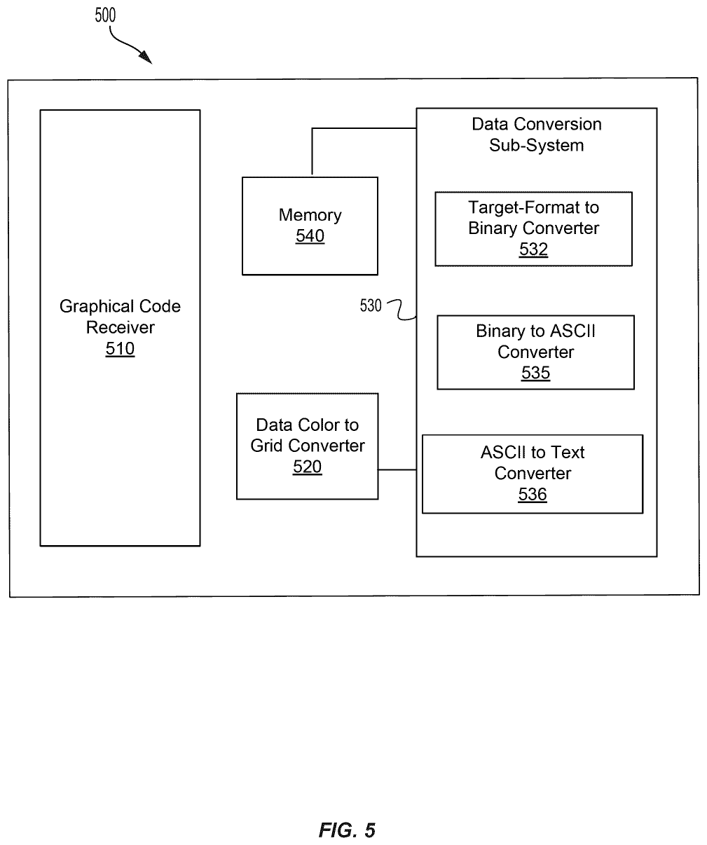

As illustrated in FIG. 5, another computing device 500—that is facilitating data sharing and interoperability based on an efficient graphical representation of data—includes a Graphical Code Receiver 510, a Data Color to Grid Converter 520, a Data-Conversion Sub-System 530 (that include a Target-Format to Binary Converter 532, a Binary to ASCII Converter 535, and an ASCII to Text Converter 536) and a Memory 540. It will be appreciated that each of one or more of the Data-Conversion Sub-System 530, Target-Format to Binary Converter 532, Binary to ASCII Converter 535, and ASCII to Text Converter 536 may correspond to specialized non-transitory code (e.g., one or more functions, code portions, sub-routines, etc.) that, when executed on a processor perform specialized function described herein. It will be appreciated that one more or all of the processing actions may be performed remotely from a device that receives, accesses, and/or transforms the graphical representation. It will also be appreciated that one more or all of the processing actions may be performed locally at a device that receives, accesses, and/or transforms the graphical representation.

The Graphical Code Receiver 510 may receive the graphical representation (or a depiction or version of the same) generated by the Graphical Code Generator 140 of another device. For example, the Graphical Code Receiver 510 may include and/or may be in communication with a camera or scanner that has captured a depiction of a graphical representation (e.g., that was printed on paper or had been displayed on another device). As another example, the Graphical Code Receiver 510 may include and/or may be in communication with a device receiver that receivers data from another device that has communicated signals indicative of the graphical representation.

The Data Color to Grid Converter 520 can transform the received graphical representation into a grid of pixel-specific values. For example, the Data Color to Grid Converter 520 can detect one or more orienting indicators and then may adjust an image property (e.g., skew, rotation, scale, perspective, etc.) accordingly. For example, a skew and/or scale may be adjusted based on a skew and/or scale difference detected in an orienting indicator (relative to a stored benchmark indicator).

The conversion performed by the Data Color to Grid Converter 520 accords with known data about the type of data depicted in the graphical representation. Thus, a precision to which pixel values are generated may differ depending on whether stored and/or received data indicates that pixel values are hexadecimal values and multi-channel values (e.g., RGB values with each channel having a value assigned along a 0-255 scale).

Each pixel value can then be converted into a binary set of values by the Target-Format to Binary Converter 532. The Target Format-to-Binary Converter 532 may apply a transformation that has partial or full reverse operations as compared to the Binary to Target-Format Converter 116. However, in some instances, the Target Format-to-Binary Converter 532 may apply one or more noise-reducing techniques that account for data patterns observed in a corresponding data set (e.g., with respect to a given client, time period, use case, etc.). The noise-reducing technique(s) may include (for example) a convolutional neural network, Transformer network, LSTM network, or other network that detects patterns and/or consistency between data points in a given context.

The binary values are converted into ASCII values by the Binary to ASCII Converter 535, and the ASCII values are converted into text (and/or numeric) values by the ASCII to Text Converter. The text that is produced by the ASCII to Text Converter 536 may, but need not, be similar to or the same as text that was initially presented to generate the graphical representation. For example, a structure converter may be used at a corresponding Data-Conversion Sub-System 110 that may have transformed the input data, such that portions of the input data were not represented or were represented in a different manner prior to generating the graphical representation. While this may have reduced the degree to which one assessment of reliable data transmission occurred, it may have increased the efficiency of data transmission and of processing at both ends (if only a subset of data is pertinent for the data processing). Further, any such selective transmission may enhance data privacy and security. In some instances, the output generated by the ASCII to Text Converter 536 includes field entries or inputs that are to be provided to a form, interface, and/or webpage to facilitate form generation and/or prediction generation given a particular circumstance.

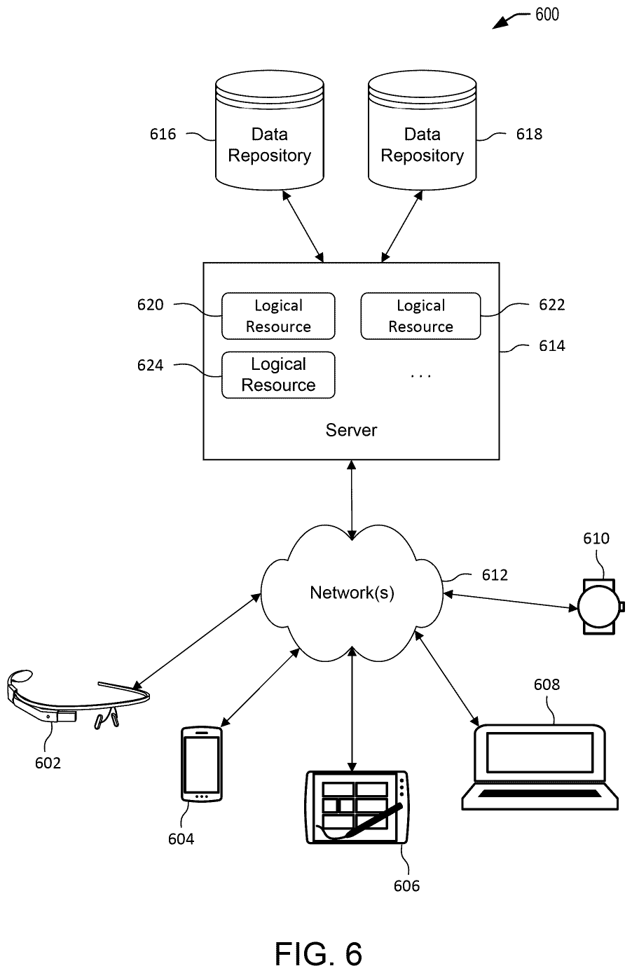

FIG. 6 depicts a simplified diagram of a distributed system 600 for implementing an embodiment. In the illustrated embodiment, distributed system 600 includes one or more client computing devices 602, 604, 606, and 608, coupled to a server 612 via one or more communication networks 610. Clients computing devices 602, 604, 606, and 608 may be configured to execute one or more applications.

In various aspects, server 612 may be adapted to run one or more services or software applications that enable techniques for handling long text for pre-trained language models.

In certain aspects, server 612 may also provide other services or software applications that can include non-virtual and virtual environments. In some aspects, these services may be offered as web-based or cloud services, such as under a Software as a Service (SaaS) model to the users of client computing devices 602, 604, 606, and/or 608. Users operating client computing devices 602, 604, 606, and/or 608 may in turn utilize one or more client applications to interact with server 612 to utilize the services provided by these components.

In the configuration depicted in FIG. 6, server 612 may include one or more components 618, 620 and 622 that implement the functions performed by server 612. These components may include software components that may be executed by one or more processors, hardware components, or combinations thereof. It should be appreciated that various different system configurations are possible, which may be different from distributed system 600. The embodiment shown in FIG. 6 is thus one example of a distributed system for implementing an embodiment system and is not intended to be limiting.

Users may use client computing devices 602, 604, 606, and/or 608 for techniques for handling long text for pre-trained language models in accordance with the teachings of this disclosure. A client device may provide an interface that enables a user of the client device to interact with the client device. The client device may also output information to the user via this interface. Although FIG. 6 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Apple Vision Pro®, Ray-Ban® Meta Smart Glasses®, Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 610 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 610 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 612 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 612 can include one or more virtual machines running virtual operating systems, or other computing architectures involving virtualization such as one or more flexible pools of logical storage devices that can be virtualized to maintain virtual storage devices for the server. In various aspects, server 612 may be adapted to run one or more services or software applications that provide the functionality described in the foregoing disclosure.

The computing systems in server 612 may run one or more operating systems including any of those discussed above, as well as any commercially available server operating system. Server 612 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 612 may include one or more applications to analyze and consolidate data feeds and/or event updates received from users of client computing devices 602, 604, 606, and 608. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 612 may also include one or more applications to display the data feeds and/or real-time events via one or more display devices of client computing devices 602, 604, 606, and 608.

Distributed system 600 may also include one or more data repositories 616, 618. These data repositories may be used to store data and other information in certain aspects. For example, one or more of the data repositories 616, 618 may be used to store information for techniques for handling long text for pre-trained language models (e.g., intent score, overall score). Data repositories 616, 618 may reside in a variety of locations. For example, a data repository used by server 614 may be local to server 614 or may be remote from server 614 and in communication with server 614 via a network-based or dedicated connection. Data repositories 616, 618 may be of different types. In certain aspects, a data repository used by server 614 may be a database, for example, a relational database, such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 616, 618 may also be used by applications to store application data. The data repositories used by applications may be of different types such as, for example, a key-value store repository, an object store repository, or a general storage repository supported by a file system.

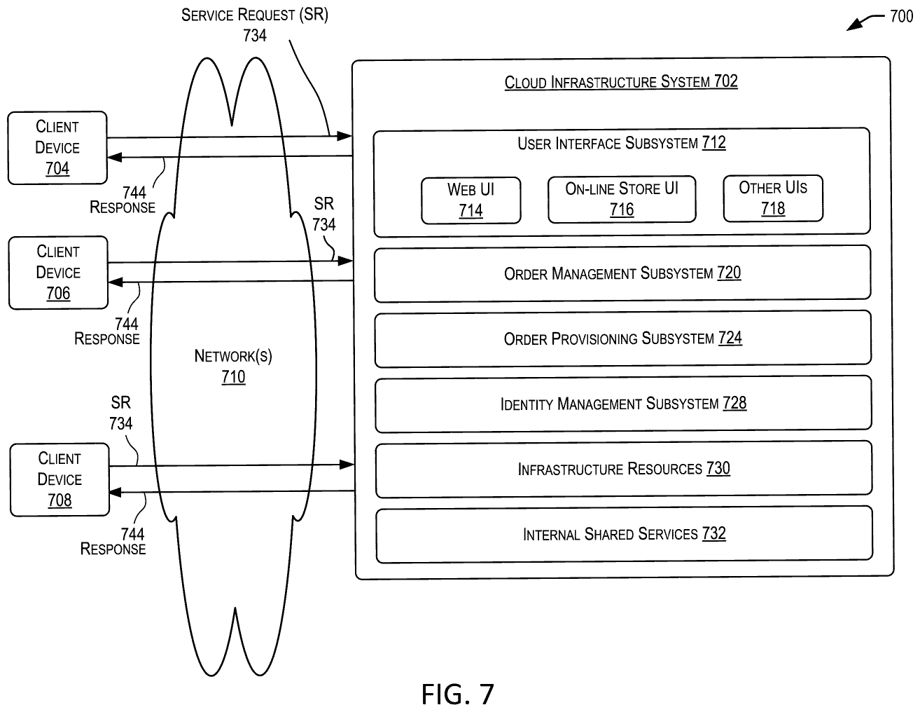

In certain aspects, the techniques for handling long text for pre-trained language models functionalities described in this disclosure may be offered as services via a cloud environment. FIG. 7 is a simplified block diagram of a cloud-based system environment in which various text handling-related services may be offered as cloud services, in accordance with certain aspects. In the embodiment depicted in FIG. 7, cloud infrastructure system 702 may provide one or more cloud services that may be requested by users using one or more client computing devices 704, 706, and 708. Cloud infrastructure system 702 may comprise one or more computers and/or servers that may include those described above for server 614. The computers in cloud infrastructure system 702 may be organized as general purpose computers, specialized server computers, server farms, server clusters, or any other appropriate arrangement and/or combination.

Network(s) 710 may facilitate communication and exchange of data between clients 704, 706, and 708 and cloud infrastructure system 702. Network(s) 710 may include one or more networks. The networks may be of the same or different types. Network(s) 710 may support one or more communication protocols, including wired and/or wireless protocols, for facilitating the communications.

The embodiment depicted in FIG. 7 is only one example of a cloud infrastructure system and is not intended to be limiting. It should be appreciated that, in some other aspects, cloud infrastructure system 702 may have more or fewer components than those depicted in FIG. 7, may combine two or more components, or may have a different configuration or arrangement of components. For example, although FIG. 7 depicts three client computing devices, any number of client computing devices may be supported in alternative aspects.

The term cloud service is generally used to refer to a service that is made available to users on demand and via a communication network such as the Internet by systems (e.g., cloud infrastructure system 702) of a service provider. Typically, in a public cloud environment, servers and systems that make up the cloud service provider's system are different from the client's own on premise servers and systems. The cloud service provider's systems are managed by the cloud service provider. Clients can thus avail themselves of cloud services provided by a cloud service provider without having to purchase separate licenses, support, or hardware and software resources for the services. For example, a cloud service provider's system may host an application, and a user may, via a network 710 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation® of Redwood Shores, California, such as middleware services, database services, Java cloud services, and others.

In certain aspects, cloud infrastructure system 702 may provide one or more cloud services using different models such as under a Software as a Service (SaaS) model, a Platform as a Service (PaaS) model, an Infrastructure as a Service (IaaS) model, and others, including hybrid service models. Cloud infrastructure system 702 may include a suite of applications, middleware, databases, and other resources that enable provision of the various cloud services.

A SaaS model enables an application or software to be delivered to a client over a communication network like the Internet, as a service, without the client having to buy the hardware or software for the underlying application. For example, a SaaS model may be used to provide clients access to on-demand applications that are hosted by cloud infrastructure system 702. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a client as a cloud service to provide elastic compute and storage capabilities. Various IaaS services are provided by Oracle Corporation®.

A PaaS model is generally used to provide, as a service, platform and environment resources that enable clients to develop, run, and manage applications and services without the client having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a client, via a subscription order, may order one or more services provided by cloud infrastructure system 702. Cloud infrastructure system 702 then performs processing to provide the services requested in the client's subscription order. Cloud infrastructure system 702 may be configured to provide one or even multiple cloud services.

Cloud infrastructure system 702 may provide the cloud services via different deployment models. In a public cloud model, cloud infrastructure system 702 may be owned by a third party cloud services provider and the cloud services are offered to any general public client, where the client can be an individual or an enterprise. In certain other aspects, under a private cloud model, cloud infrastructure system 702 may be operated within an organization (e.g., within an enterprise organization) and services provided to clients that are within the organization. For example, the clients may be various departments of an enterprise such as the Human Resources department, the Payroll department, etc. or even individuals within the enterprise. In certain other aspects, under a community cloud model, the cloud infrastructure system 702 and the services provided may be shared by several organizations in a related community. Various other models such as hybrids of the above mentioned models may also be used.

Client computing devices 704, 706, and 708 may be of different types (such as devices 602, 604, 606, and 608 depicted in FIG. 6) and may be capable of operating one or more client applications. A user may use a client device to interact with cloud infrastructure system 702, such as to request a service provided by cloud infrastructure system 702. For example, a user may use a client device to request a chat bot service described in this disclosure.

In some aspects, the processing performed by cloud infrastructure system 702 (e.g., for providing Chabot services and/or other services, such as a service employing a technique disclosed herein) may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 702 for determining the intent of an utterance. The data used for this analysis may include structured data (e.g., data stored in a database or structured according to a structured model) and/or unstructured data (e.g., data blobs (binary large objects)).

As depicted in the embodiment in FIG. 7, cloud infrastructure system 702 may include infrastructure resources 730 that are utilized for facilitating the provision of various cloud services offered by cloud infrastructure system 702. Infrastructure resources 730 may include, for example, processing resources, storage or memory resources, networking resources, and the like.

In certain aspects, to facilitate efficient provisioning of these resources for supporting the various cloud services provided by cloud infrastructure system 702 for different clients, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 702 may itself internally use services 732 that are shared by different components of cloud infrastructure system 702 and which facilitate the provisioning of services by cloud infrastructure system 702. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 702 may comprise multiple subsystems. These subsystems may be implemented in software, or hardware, or combinations thereof. As depicted in FIG. 7, the subsystems may include a user interface subsystem 712 that enables users or clients of cloud infrastructure system 702 to interact with cloud infrastructure system 702. User interface subsystem 712 may include various different interfaces such as a web interface 714, an online store interface 716 where cloud services provided by cloud infrastructure system 702 are advertised and are purchasable by a consumer, and other interfaces 718. For example, a client may, using a client device, request (service request 734) one or more services provided by cloud infrastructure system 702 using one or more of interfaces 714, 716, and 718. For example, a client may access the online store, browse cloud services offered by cloud infrastructure system 702, and place a subscription order for one or more services offered by cloud infrastructure system 702 that the client wishes to subscribe to. The service request may include information identifying the client and one or more services that the client desires to subscribe to. For example, a client may place a subscription order for a service (e.g., a Chatbot service or other service, such as one employing a technique disclosed herein) offered by cloud infrastructure system 702. As part of the order, the client may provide information identifying for input (e.g., utterances).

In certain aspects, such as the embodiment depicted in FIG. 7, cloud infrastructure system 702 may comprise an order management subsystem (OMS) 720 that is configured to process the new order. As part of this processing, OMS 720 may be configured to: create an account for the client, if not done already; receive billing and/or accounting information from the client that is to be used for billing the client for providing the requested service to the client; verify the client information; upon verification, book the order for the client; and orchestrate various workflows to prepare the order for provisioning.

Once properly validated, OMS 720 may then invoke the order provisioning subsystem (OPS) 724 that is configured to provision resources for the order including processing, memory, and networking resources. The provisioning may include allocating resources for the order and configuring the resources to facilitate the service requested by the client order. The manner in which resources are provisioned for an order and the type of the provisioned resources may depend upon the type of cloud service that has been ordered by the client. For example, according to one workflow, OPS 724 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting client for providing the requested service.

Cloud infrastructure system 702 may send a response or notification 744 to the requesting client to indicate when the requested service is now ready for use. In some instances, information (e.g., a link) may be sent to the client that enables the client to start using and availing the benefits of the requested services.

Cloud infrastructure system 702 may provide services to multiple clients. For each client, cloud infrastructure system 702 is responsible for managing information related to one or more subscription orders received from the client, maintaining client data related to the orders, and providing the requested services to the client. Cloud infrastructure system 702 may also collect usage statistics regarding a client's use of subscribed services. For example, statistics may be collected for the amount of storage used, the amount of data transferred, the number of users, and the amount of system up time and system down time, and the like. This usage information may be used to bill the client. Billing may be done, for example, on a monthly cycle.

Cloud infrastructure system 702 may provide services to multiple clients in parallel. Cloud infrastructure system 702 may store information for these clients, including possibly proprietary information. In certain aspects, cloud infrastructure system 702 comprises an identity management subsystem (IMS) 728 that is configured to manage client's information and provide the separation of the managed information such that information related to one client is not accessible by another client. IMS 728 may be configured to provide various security-related services such as identity services, information access management, authentication and authorization services, services for managing client identities and roles and related capabilities, and the like.

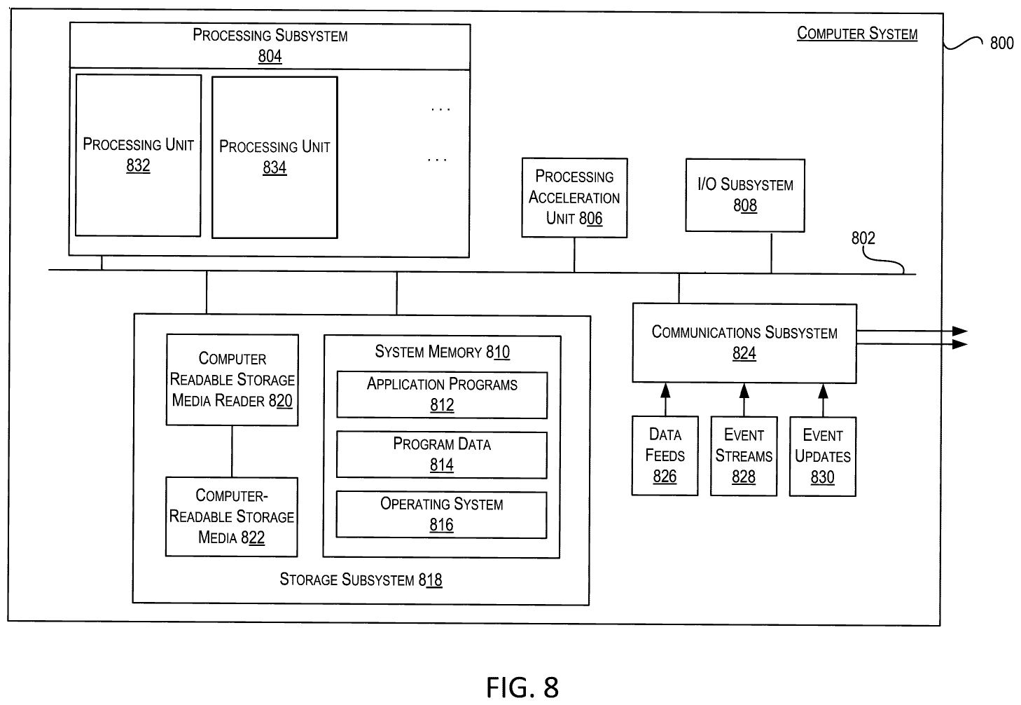

FIG. 8 illustrates an exemplary computer system 800 that may be used to implement certain aspects. For example, in some aspects, computer system 800 may be used to implement any of the system 100 for enriching log records with fields from other log records in structured format as shown in FIG. 1 and various servers and computer systems described above. As shown in FIG. 8, computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. Storage subsystem 818 may include non-transitory computer-readable storage media including storage media 822 and a system memory 810.

Bus subsystem 802 provides a mechanism for letting the various components and subsystems of computer system 800 communicate with each other as intended. Although bus subsystem 802 is shown schematically as a single bus, alternative aspects of the bus subsystem may utilize multiple buses. Bus subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of computer system 800 and may comprise one or more processors, application specific integrated circuits (ASICs), or field programmable gate arrays (FPGAs). The processors may include be single core or multicore processors. The processing resources of computer system 800 can be organized into one or more processing units 832, 834, etc. A processing unit may include one or more processors, one or more cores from the same or different processors, a combination of cores and processors, or other combinations of cores and processors. In some aspects, processing subsystem 804 can include one or more special purpose co-processors such as graphics processors, digital signal processors (DSPs), or the like. In some aspects, some or all of the processing units of processing subsystem 804 can be implemented using customized circuits, such as application specific integrated circuits (ASICs), or field programmable gate arrays (FPGAs).

In some aspects, the processing units in processing subsystem 804 can execute instructions stored in system memory 810 or on computer readable storage media 822. In various aspects, the processing units can execute a variety of programs or code instructions and can maintain multiple concurrently executing programs or processes. At any given time, some or all of the program code to be executed can be resident in system memory 810 and/or on computer-readable storage media 822 including potentially on one or more storage devices. Through suitable programming, processing subsystem 804 can provide various functionalities described above. In instances where computer system 800 is executing one or more virtual machines, one or more processing units may be allocated to each virtual machine.

In certain aspects, a processing acceleration unit 806 may optionally be provided for performing customized processing or for off-loading some of the processing performed by processing subsystem 804 so as to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information to computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device (e.g., Apple Vision Pro®, Ray-Ban®Meta Smart Glasses®, Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 800 to a user or other computers. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics, and audio/video information such as monitors, printers, speakers, headphones, automotive navigation systems, plotters, voice output devices, and modems.

Storage subsystem 818 provides a repository or data store for storing information and data that is used by computer system 800. Storage subsystem 818 provides a tangible non-transitory computer-readable storage medium for storing the basic programming and data constructs that provide the functionality of some aspects. Storage subsystem 818 may store software (e.g., programs, code modules, instructions) that when executed by processing subsystem 804 provides the functionality described above. The software may be executed by one or more processing units of processing subsystem 804. Storage subsystem 818 may also provide a repository for storing data used in accordance with the teachings of this disclosure.

Storage subsystem 818 may include one or more non-transitory memory devices, including volatile and non-volatile memory devices. As shown in FIG. 8, storage subsystem 818 includes a system memory 810 and a computer-readable storage media 822. System memory 810 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 800, such as during start-up, may typically be stored in the ROM. The RAM typically contains data and/or program modules that are presently being operated and executed by processing subsystem 804. In some implementations, system memory 810 may include multiple different types of memory, such as static random access memory (SRAM), dynamic random access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 822 may store programming and data constructs that provide the functionality of some aspects. Computer-readable media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, digital video disc (DVD), a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 818 may also include a computer-readable storage media reader 820 that can further be connected to computer-readable storage media 822. Reader 820 may receive and be configured to read data from a memory device such as a disk, a flash drive, etc.

In certain aspects, computer system 800 may support virtualization technologies, including but not limited to virtualization of processing and memory resources. For example, computer system 800 may provide support for executing one or more virtual machines. In certain aspects, computer system 800 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices. For example, the communication subsystem may be used to transmit a response to a user regarding the inquiry for a service (e.g., a Chatbot service or other service, such as one employing a technique disclosed herein).

Communication subsystem 824 may support both wired and/or wireless communication protocols. For example, in certain aspects, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 824 can provide wired network connectivity (e.g., Ethernet) in addition to or instead of a wireless interface.

Communication subsystem 824 can receive and transmit data in various forms. For example, in some aspects, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a personal digital assistant (PDA)), a wearable device (e.g., a Google Glass® head mounted display), a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, a person of ordinary skill in the art can appreciate other ways and/or methods to implement the various aspects.

It will be appreciated that techniques disclosed herein provide multiple technical advantages. For example, the techniques support communicating a large amount of data very efficiently. Thus, dependency on underlying record or computer systems (e.g., EHR or HIE systems) is reduced, and the data communication can function offline. The techniques can be used to communicate any type of alphanumeric data and can enable interoperability across non-connected facilities (that may use different file systems). When structured data is encoded, the efficiency at which the data can be represented is even higher, as standard or shared baseline information may indicate what type of data is presented at various pixels.

### Example 1—Mapping Efficiency-Hexadecimal Target

In this Example, a full-HD image includes 1920×1080 pixels. If each hexadecimal value is represented with one pixel, a total of 2,073,600 hexadecimal values are generated (1920 multiplied by 1080). The storage of 2073600 hexadecimal values corresponds to the storage of 8,294,400 bits of data, which—when compared to a QR Code storage capacity—may be many folds higher. The storage capacity varies depending on the image size and the number of pixels used to represent a hexadecimal character (Table 1 and Table 2, illustrating a relation between data storage capacity and corresponding set of pixels). Additionally, the number of pixels can be updated as per reader/decoder capabilities in the computing device where the XS-code is decoded to extract the information.

TABLE 1

| | | | |
|---|---|---|---|
| | | Total Hexadecimal | |
| Pixel | Hexadecimal Blocks | Blocks | Bits |

Full-HD Image - 1920 × 1080

| | | | |
|---|---|---|---|
| 1 Pixel | 1920 × 1080 | 2073600 | 8294400 |
| 2 Pixel | 960 × 1080 | 1036800 | 4147200 |
| 4 Pixel | 960 × 540 | 518400 | 2073600 |
| 6 Pixel | 640 × 540 | 345600 | 1382400 |
| 8 Pixel | 480 × 540 | 259200 | 1036800 |

HD Image - 1280 × 720

| | | | |
|---|---|---|---|
| 1 Pixel | 1280 × 720 | 921600 | 3686400 |
| 2 Pixel | 640 × 720 | 460800 | 1843200 |
| 4 Pixel | 640 × 360 | 230400 | 921600 |
| 8 Pixel | 320 × 360 | 115200 | 460800 |

In some embodiments, to further enhance the data storage capability in the digitally encoded images, the digitally encoded image may further be generated corresponding to WS-Code and PS-Code encoding scheme. For example, ASCII value corresponding to the data-set may be associated with a set of pixels including 2 Blocks/Pixels per ASCII Value for XS-code based on Hexadecimal values, 1 Blocks/Pixels per ASCII Value for WS-Code, 3 ASCII Values per Block/Pixel for 8-bit PS-Code, and 12 ASCII Values per Block/Pixel for 32-bits PS-Code. Please see tables 2 and 3 below for supporting details.

TABLE 2

| XS-code | WS-Code | PS-Code |
|---|---|---|
| Custom Color- | Grey Scale | RGB |
| Hexadecimal | | |
| 0-16 | 0-255 | 0-255 (RGB) |
| 2 Blocks/Pixels per | 1 Blocks/Pixels per | 3 ASCII Values per |
| ASCII Value | ASCII Value | Block/Pixel |

Full-HD Image - 1920 × 1080 (ASCII Values)

| | | |
|---|---|---|
| 1036800 | 2073600 | 6220800 |

Full-HD Image - 1920 × 1080 (Bits)

| | | |
|---|---|---|
| 8294400 | 16588800 | 49766400 |

TABLE 3

| | | PS-Code | PS-Code |
|---|---|---|---|
| XS-code | WS-Code | (8 Bits) | (32-Bits) |
| 2 Blocks/ | 1 Blocks/ | 3 ASCII | 12 ASCII |
| Pixels per | Pixels per | Values per | Values per |
| ASCII Value | ASCII Value | Block/ | Block/ |
| | | Pixel | Pixel |

In some embodiments, the digitally encoded image generated corresponding to WS-Code and PS-Code encoding scheme, respectively may use a combination of different color palette including RGB, grayscale, etc. For example, for generating a digitally encoded image based on WS-Code, each ASCII value may be assigned a corresponding pixel and/or a color block on a grid. The grid may be used to associate a color selected from grayscale color palette. For generating a digitally encoded image based on PS-Code, at least three ASCII values may be assigned a corresponding pixel and/or a color block on a grid. The grid may be used to associate a color selected from RGB color palette. In some embodiments, the digitally encoded images generated based on WS-Code and PS-code may be shared and/or communicated to a computing device of a requesting/receiving entity. For example, the digitally encoded images generated based on WS-Code and PS-code may be shared as .png image file to the computing device.

The association of one or more pixel(s) and/or color block(s) with the combination of varied color palette including grayscale color palette, RGB color palette may further enhance data storage capabilities. For example, in the digitally encoded image based on WS-code, one pixel and/or color block may be associated with each ASCII value. Considering an exemplary scenario where the digitally encoded image corresponds to a full-HD image having 1920×1080 pixels, almost 2073600 blocks storing approximately 8294400 bits of data may be stored. Considering another exemplary scenario where the digitally encoded image based on PS-code encoding scheme, corresponds to a full-HD image having 1920×1080 pixels, almost 6220800 blocks may encompass data. The data storage discussed in the afore-mentioned exemplary scenario(s) herein may be many folds higher than the data storage capability of the QR code.

### Example 2—Exemplary Storage of Medical Data

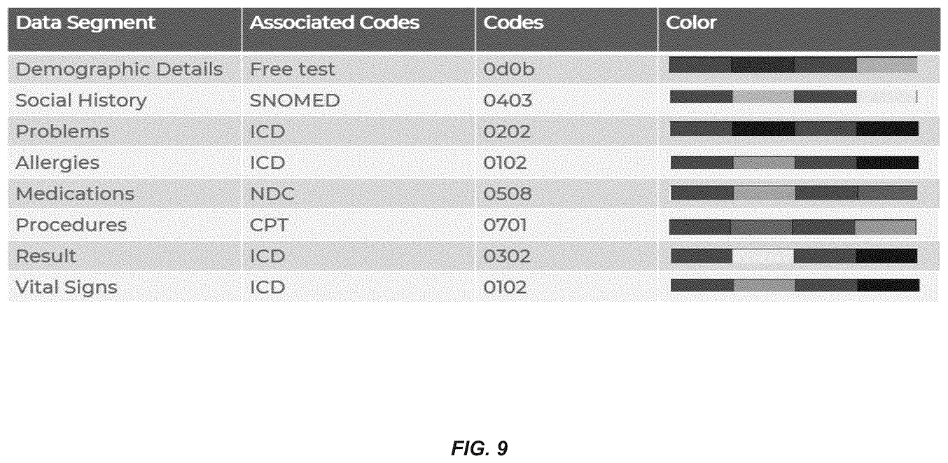

Medical data can be included into XS-code in standard medical terminologies (ICD, SNOMED-CT, CPT etc.) which can aid with reducing the data size and enabling highly structured coded data transfer. (See Tables 4-7, which shows relation between the data segments and data compression relation between the data segments, and FIG. 9, which shows encoding to a standard medical terminology.) If the XS-Code is represented in sections (as in FIG. 3B), each of multiple medical data segments (e.g., a medical issue, allergy, medication, etc.) can be represented by an encoded value, along with respective Medical Terminology used to represent data in it. For example, if Procedures are represented in CPT terminology, Procedures can be given an identifier as 04 and CPT terminology as 01 on the Hexadecimal scale and accordingly represented with respective colors at a starting or any other defined position of the XS-Code segment. This can allow a decoder to identify what the section represents along with the respective medical terminology being used.

Table 4 shows a relation between the data segments including demographic details, social history, problems, allergies, medications, procedures, result, vital signs, etc. for a simulated subject, length of the data segments, and a bit size corresponding to the data segments. Table 5 shows a relation between the data segments, initial bit size corresponding to the data segments and the bit size subjected to Huffman compression technique. Table 6 shows a relation between the data segments, the initial bit size corresponding to the data segments subjected to Huffman encoding technique, and further conversion of the data segments subjected to Huffman encoding technique into hexadecimal characters. Table 7 shows a relation between the data segments, the initial bit size corresponding to the data segments subjected to Huffman encoding technique, conversion of the data segments subjected to Huffman encoding technique into hexadecimal characters, and compression ratio. Therefore, Tables 4-7 show data indicating how the graphical representations performed in accordance with embodiments disclosed herein provide encoding into standard medical terminologies and data compression to improve and enhance data storage and representation capabilities.

TABLE 4

| Data Segment | Length | Bits Size |
|---|---|---|
| Demographic Details | 181 | 1448 |
| Social History | 211 | 1688 |
| Problems | 120 | 960 |
| Allergies | 146 | 1168 |
| Medications | 181 | 1448 |
| Procedures | 705 | 5640 |
| Result | 860 | 6880 |
| Vital Signs | 79 | 632 |

TABLE 5

| Data Segment | Initial Bits Size | Huffman Encoding |
|---|---|---|
| Demographic Details | 1448 | 882 |
| Social History | 1688 | 934 |
| Problems | 960 | 526 |
| Allergies | 1168 | 660 |
| Medications | 1448 | 839 |
| Procedures | 5640 | 3256 |
| Result | 6880 | 3749 |
| Vital Signs | 632 | 380 |

TABLE 6

| | | Hexadecimal |
|---|---|---|
| Data Segment | Huffman Encoding | Characters |
| Demographic Details | 882 | 221 |
| Social History | 934 | 234 |
| Problems | 526 | 132 |
| Allergies | 660 | 165 |
| Medications | 839 | 210 |
| Procedures | 3256 | 814 |
| Result | 3749 | 938 |
| Vital Signs | 380 | 95 |

TABLE 7

| Data | Original | Hexadecimal | Compression |
|---|---|---|---|
| Segment | Bits Size | Characters | Ratio |
| Demographic | 1448 | 221 | 9:1.374 |
| Details | | | |
| Social History | 1688 | 234 | 9:1.248 |
| Problems | 960 | 132 | 9.1238 |
| Allergies | 1168 | 165 | 9:1.271 |
| Medications | 1448 | 210 | 9:1305 |
| Procedures | 5640 | 814 | 9:1299 |
| Result | 6880 | 938 | 9:1.227 |
| Vital Signs | 632 | 95 | 9:1.353 |

### Example 3—Exemplary Process Flows Involving XS-Codes

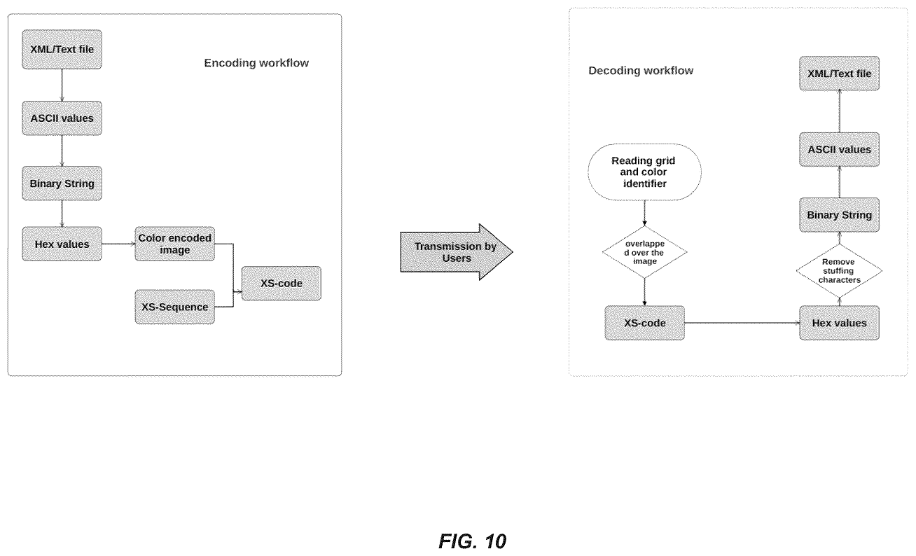

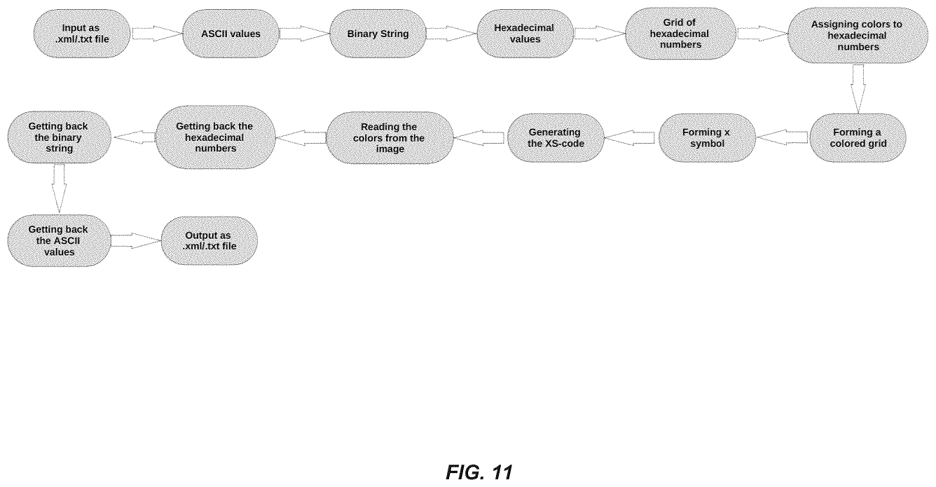

FIGS. 10 and 11 show exemplary process flows involving XS-Codes (with hexadecimal signals). A file that is received is an XML or text file. The file is transformed into a set of Ascii values, which are then converted into a binary string. The binary string is transformed into hex values, which is then converted into a color encoded image. In some embodiments, each hex value is translated into a color for two pixels (e.g., positioned adjacent to each other in the color encoded image). An X-sequence is retrieved, where the X-sequence includes a predefined format and/or identifier that XS-codes are to have. The X-Sequence defines the orientation of the XS-Code; meaning the side from which the decoder should start reading or decoding the encoded image. For example, the X-sequence may include an indicator that is to represent which pixel in the color-encoded image is a first pixel, and/or the X-sequence may include specifications of one or more borders that are to be applied around part or all of the color encoded image. An XS-code is then generated using the color-encoded image and the X-sequence.

At the decoding stage, a reading grid and color identifier is accessed. The reading grid and color identifier may include standard information indicating how the XS-code is to be read, processed and/or interpreted. For example, the reading grid may indicate how to identify a first pixel, how to scale an XS-code to ensure that each pixel is detected, what potential colors may be represented in the XS-grid, etc. The reading grid and color identifier can then be used to preprocess the received XS-code. Pixel colors are then detected and converted into hex values. Any stuffing characters (e.g., borders or a pixel color indicating a lack of data for a field corresponding to a given pixel) are removed, and the hex values are converted to a binary string. The binary string is transformed into a set of ascii values, which are then converted into an XML or text file.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed:

1. A computer-implemented method comprising:
receiving a data set in a first specific format;
transforming the data set into data-string values in a second specific format, wherein the data-string values includes a set of data-string values, wherein each of the set of data-string values is represented by an intensity for each of one or more channels;
generating a digitally encoded image by transforming the data-string data into an image comprising a pixel value for each of a set of pixels, wherein the pixel values for the set of pixels have at least three different intensities and/or at least three different colors relative to each other;
outputting the digitally encoded image.

2. The computer-implemented method of claim 1, wherein the transformation includes:
transforming the data set from the first specific format into another data set in a ASCII format.

3. The computer-implemented method of claim 2, wherein the transformation includes:
transforming the other data set in the ASCII format to data in a binary format.

4. The computer-implemented method of claim 1, wherein the transformation includes:
generating the data set or a representation thereof in a hexadecimal format.

5. The computer-implemented method of claim 1, wherein the transformation includes:
generating data in a hexadecimal format, wherein the hexadecimal format utilizes one or more pixels to represent a given hexadecimal value.

6. The computer-implemented method of claim 1, wherein the transformation includes:
generating data in a grayscale format, wherein the grayscale format is configured to use a scale with at least three distinct values.

7. The computer-implemented method of claim 1, wherein the transformation includes:
generating data in a multi-channel color format, such that each or multiple pixels in the digitally encoded image is represented by a set of channel values that were generated based on the data set.

8. The computer-implemented method of claim 1, wherein outputting the digitally encoded image includes presenting the digitally encoded image.

9. The computer-implemented method of claim 1, wherein outputting the digitally encoded image includes transmitting the digitally encoded image.

10. The computer-implemented method of claim 1, wherein generating a digitally encoded image further comprises integrating an orienting indicator to facilitate adjusting skew, scale, or orientation of the digitally encoded image.

11. The computer-implemented method of claim 1, wherein the pixel values of the set of pixels in the digitally encoded image include grayscale values.

12. The computer-implemented method of claim 1, wherein the pixel values of the set of pixels in the digitally encoded image include multi-channel color values.

13. The computer-implemented method of claim 1, wherein the transformation includes:
transforming a received graphical representation into a grid of pixel-specific values to detect one or more orienting indicators and adjusting an image property.

14. The computer-implemented method of claim 1, wherein the digitally encoded image includes a portion that includes an additional set of pixels that are ordered or labeled in a manner that indicates, for each pixel of the additional set of labels, a data value that the pixel is to represent.

15. A system comprising:
one or more data processors; and
a non-transitory computer readable storage medium containing instructions which, when executed on the one or more data processors, cause the one or more data processors to perform a set of actions including:
receiving a data set in a first specific format;
transforming the data set into data-string values in a second specific format, wherein the data-string values includes a set of data-string values, wherein each of the set of data-string values is represented by an intensity for each of one or more channels;
generating a digitally encoded image by transforming the data-string data into an image comprising a pixel value for each of a set of pixels, wherein the pixel values for the set of pixels have at least three different intensities and/or at least three different colors relative to each other;
outputting the digitally encoded image.

16. A computer-program product tangibly embodied in a non-transitory machine-readable storage medium, including instructions configured to cause one or more data processors to perform a set of actions including:
receiving a data set in a first specific format;
transforming the data set into data-string values in a second specific format, wherein the data-string values includes a set of data-string values, wherein each of the set of data-string values is represented by an intensity for each of one or more channels;
generating a digitally encoded image by transforming the data-string data into an image comprising a pixel value for each of a set of pixels, wherein the pixel values for the set of pixels have at least three different intensities and/or at least three different colors relative to each other;
outputting the digitally encoded image.

17. The computer-program product of claim 16, wherein the transformation includes:
transforming the data set from the first specific format into another data set in a ASCII format.

18. The computer-program product of claim 17, wherein the transformation includes:
transforming the other data set in the ASCII format to data in a binary format.

19. The computer-program product of claim 16, wherein the transformation includes:
generating the data set or a representation thereof a in hexadecimal format.

20. The computer-program product of claim 16, wherein the transformation includes:
generating data in a hexadecimal format, wherein the hexadecimal format utilizes one or more pixels to represent a given hexadecimal value.
